(19) United States
(12) Patent Application Publication
(10) Pub. No.: US 2014/0261406 A1
(43) Pub. Date: Sep. 18, 2014

(54) SAFETY VEST FLOATATION SYSTEM WITH OXYGEN SUPPLY

(71) Applicant: Mark Edward Fabian, Miami, FL (US)

(72) Inventor: Mark Edward Fabian, Miami, FL (US)

(21) Appl. No.: 13/830,938

(22) Filed: Mar. 14, 2013

(51) Int. Cl. B63C 9/18; A62B 17/04; A62B 9/06; A62B 7/04; A62B 7/12; A62B 9/02

(52) U.S. Cl. CPC B63C 9/18; A62B 7/12; A62B 9/02; A62B 9/06; A62B 7/04; A62B 17/04
USPC 128/202.14

(57) ABSTRACT

A safety vest flotation system wearable by airline or water ferry passengers is folded and stowed below the seat. The vest is worn by slipping the head through a central aperture and securing the waist belt. Air chamber cells surround the chest. Plural pressurized air or oxygen cylindrical cartridges are integrally attached to the vest. These cartridges are activated to release their contents to air chamber cells. A breathing tube is connected to air chamber cells at the proximal end. The breathing tube has a closure valve midway and a mouthpiece at its distal end. During a cabin smoke event, the user dons the vest, activates the cartridges to inflate air chamber cells, places the mouthpiece in the mouth and opens the closure valve. Fresh air received through the tube prevents smoke induced affixation. During a water accident, the closure valve is closed to provide buoyancy and thereby prevent drowning.

### FIELD OF THE INVENTION

The present invention relates to inflatable survival vests; and, more particularly, to an under seat vest that can be worn by a passenger on an airline, water ferry or boat, to provide breathing capability in a smoky environment caused by cabin fire, as well as floatation of the passenger in a water accident.

### DESCRIPTION OF THE PRIOR ART

Various types of masks are available in the market place. These masks are pressurized by regulated air from a high-pressure tank. There are also commercially available under seat vests for use by air line passengers. These under seat vests may be inflated from carbon dioxide cartridges to facilitate floatation of a passenger in a water accident.

U.S. Pat. No. 3,976,063 to Henneman, et al. discloses escape breathing apparatus. This method and system supplies a person with breathable fluid in an irrespirable atmosphere. A package which is attached to a person holds a container having a valve which is activated upon removal of a protective cover. The valve allows a breathable fluid to flow at a variable rate to a supply conduit. The supply conduit is connected to a reservoir. An inhalation check valve connects the supply conduit to the person. Upon inhalation, the check valve will open and allow breathable fluid to flow from the supply conduit. Upon exhalation, the inhalation check valve closes and an exhalation check valve opens to permit the breathed air to flow through a filter where carbon dioxide is removed before returning to be mixed with breathable fluid in the supply conduit. The breathable fluid supply is contained in a bottle. The facemask is contained in a package and must be removed by pulling on a zipper prior to use. The action of pulling a zipper to remove the facemask punctures a diaphragm allowing the breathable fluid to fill the facemask and provide breathable fluid to the user. Inhalation opens a valve to supply the breathable fluid while exhalation opens another valve circulating the breathed fluid to remove carbon dioxide and moisture before it can be returned to the facemask. This escape breathing apparatus is not a floatation apparatus. The breathable pressure in the hood has to be reduced to allow the user to breathe comfortably.

U.S. Pat. No. 4,324,234 to Maness discloses a dual chamber personal flotation device. The dual chamber personal flotation device allows rebreathing into it. One of the chambers is for flotation only and is inflated with CO₂; the other is for rebreathing, and is inflated with air. A tube located close to the wearer's mouth has a combination mouthpiece-shutoff valve on it which is designed to collect a minimum amount of water prior to being inserted in the wearer's mouth, thereby minimizing problems due to water ingestion during rebreathing. The chambers are independently inflatable in the event that either the size or the buoyancy has to be minimized in order to escape. The device has two chambers, one filled with CO₂ gas from a cylinder floatation and other filled with air useful for breathing. This is a large device and must be worn at all times. Due to its large size and wearing requirements, it cannot be used by an airline passenger and is not susceptible to being placed under the seat of an airline or water ferry.

U.S. Pat. No. 4,440,163 to Spergel discloses an emergency escape breathing apparatus. This emergency escape breathing apparatus comprises a relatively rigid and transparent face mask attachable to the head of the wearer, a pressurized bottle supply of air or oxygen-enriched air adapted to be fed to said mask by a flow control assembly. This assembly includes a rupturable diaphragm valve and a pressure-reducing reservoir, the valve at one end being connected to the mouth of the pressurized bottle, at the other end being connected to the reservoir inlet, a flexible hose at one end being connected to the face mask and at the other end being connected to the outlet of the reservoir. The assembly is adapted to provide conditions of pressure and gas content within the mask for respiratory requirements for predetermined brief periods of time to bridge the emergency interval. Accordingly, the facemask has a functioning exhalation valve and may also be provided with filters to eliminate inhalation of toxic elements in the ambient air and/or aid or substitute for said exhalation valve. The apparatus is of unitary structure, supportable and depending from the mask, capable of being folded into a compact unit and discardable after a single usage. The apparatus uses a mask that is fed with regulated pressurized air from a bottle and is a cumbersome device. This device does not permit floatation of an airline or water ferry passenger when immersed in water due to a water accident.

U.S. Pat. No. 4,889,113 to Pelloux-Gervais, et al. discloses a hood for protecting against smoke and hypoxia. This hood is of use more particularly in the protection of flying personnel in aircraft. The hood comprises, at its base and within the fluid tight cover a closed tube surrounding the neck of the wearer and containing a reserve supply of oxygen under pressure. Means are provided for automatically putting the interior of this tube in communication with an automatic supply of oxygen to the wearer of the hood, when the hood is donned. This device uses a hood for one time use that contains an oxygen supply within the bottom tube that is punctured for the delivery of oxygen into the hood. The hood also contains carbon dioxide absorbing materials so as to remove the carbon dioxide caused by breathing. This hood is not indicated to assist the user in floatation when immersed in water.

U.S. Pat. No. 4,964,405 to Arnoth discloses emergency respiration apparatus. This compact, lightweight, self-contained self-rescuer unit has a source of pressurized breathable gas. The breathing bag has a plurality of collapsible channels and CO₂ absorption means disposed within the channels. The unit is preferably configured in the form of a vest. This apparatus has a combined regulator, demand sensor and timed release valve supplying regulated pressurized oxygen to collapsible tubes in a vest, each tube having carbon dioxide removal features. The vest is not indicated to provide floatation for the user when immersed in water.

U.S. Pat. No. 4,996,982 to Williamson (hereinafter, “the '982 patent”) discloses an emergency breathing apparatus with holster released regulator valve. This short, compact pressure cylinder filled with compressed air under about 3000 psi operating pressure is provided with a scuba type breathing regulator attached to the top thereof. A quick release holster surrounds the cylinder and is easily attached to any flight suit or vest, which may be worn by a user. Attached to the holster is a mouthpiece cover to keep the mouthpiece and the breathing chamber of the regulator clean and free of debris. The apparatus is easily operated and automatically activated simply by pulling the cylinder from the holster in a single movement. This removal of the cylinder from the holster acts to simultaneously remove the mouthpiece cover and open a supply valve in the regulator, permitting air to be supplied to the regulator valve. The apparatus is sealed at the place of manufacturing and is designed to be virtually maintenance free. This is a small air cylinder fitted with a regulator and terminates in a cable that carries the mouthpiece. The breathing apparatus does not provide floatation features for a passenger when immersed in water.

U.S. Pat. No. 6,247,471 to Bower, et al. discloses a smoke hood with oxygen supply device and method of use. This emergency breathing device includes a hood. The device has use and storage configurations, which when compactly wrapped proximate to an oxygen control device for storage is recoverable for use. In use configuration, the hood is capable of being worn upon a user's head, which surrounds the user's head. Hood surface beneath the user's head includes an opening lined with elastic material, which forms a seal about the user's neck at the opening when the hood is donned. An oxygen control device connected to a hood includes a valve body, an actuator, and an oxygen bottle. The valve body provides airflow communication with the interior of the hood, and the oxygen control device is connected to a plumbed breathable oxygen supply through a plumbed source disconnect means removably connected to the valve body. When connected, the oxygen control device permits airflow from the plumbed breathable oxygen supply and valve body to the interior of the hood. A cam within the valve body rotates with the operation of the actuator for engaging a piercing member to pierce the oxygen bottle, causing oxygen to flow from the oxygen bottle to the interior of the hood and forcing the plumbed source disconnect mechanism to simultaneously disconnect from the valve body. The user may therefore don the hood to receive breathable oxygen initially from the plumbed source and then from the oxygen bottle upon operation of the actuator and release from the plumbed source. This is a small air cylinder fitted with a shutoff means and connects to oxygen supply tube, which feeds the hood. The breathing apparatus does not provide floatation features for a passenger when immersed in water.

U.S. Pat. No. 7,261,608 to Haddacks discloses a vest with air bag. This vest with air bag is a durable survival vest with shoulder pads and a front chest protector having ventilation holes there through and an attached air bag. The vest includes a shell defining a neck opening, a torso opening, and a pair of opposed armholes. The vest also has a chest protector attached to the shell and an air bag attached to the chest protector. The vest includes a cartridge/canister, an activator, and a D-ring. The vest may include a power source, a sensor, a die marker, a cartridge/canister, an activator, a positioning device, a communication device, an antenna, control logic, and a communication bus. The D-ring is configured to operatively engage the activator to release breathable gas from the cartridge/canister when the D-ring is pulled by a user. This vest protects the user during a snow avalanche by expanding the air bag surrounding the chest of the user when the cartridge is released manually or released by an automatic microprocessor. This expansion displaces the snow around the user creating a space. The air bag slowly releases air through holes present and contracts. The air released in the contracted space provides breathable air to the user, preventing suffocation. This inflatable survival vest with air bag provides a protective safety measure for skiers in case of an avalanche. This vest is not usable by a passenger in an airline or water ferry since it has to be worn all the time. Due to deflation of the filled air bag, the device cannot provide floatation when the person wearing the airbag enters water.

U.S. Pat. No. 7,854,639 to Leal, et al. discloses a flotation assembly with monitoring device. This flotation assembly is adapted to be installed beneath the seat of a commercial airline and comprises a base structured and configured to define a life vest intended to support an individual in a body of water. A monitoring device preferably comprising a radio frequency identification device or RFID tag structured for wireless communication is connected to the life vest in a predetermined location, which generally restricts physical access thereto but does not interfere with wireless communication therewith. As such, an appropriate reader assembly may be brought into the general vicinity of the RFID tags associated with a plurality of the life vests, thereby facilitating the efficient inspection of each of the life vests. This vest is a conventional airline under seat floatation device and includes one or two gas canisters, which release the gas to inflatable cells upon activation of a pull cord or handle. The gas contained in the canisters is not indicated to be air or oxygen and the inflated cells to do not provide breathing air or oxygen to the user. The filled cells merely provide floatation of the user when immersed in water. The gas contained in the canisters is not indicated to be rich in oxygen and therefore is not breathable.

U.S. Published Patent Application No 20120048275 to Cowgill discloses a rebreather vest. This closed circuit rebreather uses a vest with an airtight internal cavity that has a channel. The channel passes through a series of passageways either on a single layer or a double layer. Located throughout the length of the channel is a CO₂ scrubbing material. A person exhales which causes the exhaled breath to enter one end of the channel and pass through the channel while being scrubbed of CO₂ and when the user inhales, fully scrubbed air is drawn from the opposing end of the channel. Appropriate spacers, either V-shaped separators or ribs of various designs can be used to hold the channel open. This rebreather vest uses one or two separate air or oxygen pressurized cylinders with closure valves on top. The pressure to breathing mouthpiece is regulated. The channels of the vest through which air passes have carbon dioxide absorbing chemical compounds and the air previously used for breathing is recirculated. This device is not small enough to fit under the seat of airline or water ferry due to the use of large pressurized tanks. Besides, the vest is not indicated to provide floatation for the passenger during a water event.

Based on the foregoing, there exists a need in the art for a compact vest that can fit under the seat of an airline or water ferry and when worn by the passenger provides breathing capability in a smoky cabin as well as facilitating floatation of the passenger during a water event.

### SUMMARY OF THE INVENTION

The present safety vest floatation system with oxygen supply provides an under seat vest that can be worn by an airline or water ferry passenger. The vest has integrally attached one or two cartridges of air and the air contained therein is released to one or two vest cells present adjacent to the chest of the user by activating a pull lever or a pull belt. The air cell has an attached breathing tube with a closure valve present and terminates in a mouthpiece similar to a under water snorkel. In the event of smoke in the airline or water ferry cabin, the user may activate the filling of the air cells by pulling the pull lever or pull belt provided releasing the content of the air cartridge into the vest cells. Next the closure valve on the breathing tube is opened and the mouthpiece is placed within the mouth of the user to receive breathable air. If the passenger is immersed in water due to a water-landing event, the user wears the vest, activates the filling of the vest cells with the breathing tube valve closed. The filled air cells provide buoyancy thereby preventing drowning of the passenger. The breathing tube may be used to blow additional air into the air cells when the breathing tube valve is momentarily opened to increase buoyancy of the vest.

Briefly stated, the airline under seat vest of the present invention provides a safety apparatus that assists floatation of an airline passenger wearing the vest during a water event. It additionally provides reserve clean air supply when there is smoke in the cabin providing critical valuable minutes of survival, preventing smoke induced affixation. While the invention is geared to an under seat airline passenger survival kit, it is equally well adapted for use in a marine application.

The key feature of the invention is a vest that can be compactly folded and placed under the seat of an airline seat or a marine bench. The vest is slipped over the head of a passenger through a central aperture and secured using a waist belt. The vest has integrally attached two or more cartridges of pressurized air or oxygen that can be discharged to fill and inflate air chamber cells that surround the chest of the passenger. The cells connect to a breather tube that has a closure valve midway and terminates in a mouthpiece. In the event of smoke in the cabin, the breather tube valve is opened and the mouthpiece is placed within the mouth of the passenger, similar to an under water snorkel, protecting the passenger from affixation by the inhalation of smoke. The inflated cells surrounding the chest of the passenger also provide floatation support when the breathing tube valve is closed, should the passenger fall into water and trigger a water event. The breathing valve may be used to manually increase the inflation and buoyancy of the cells.

Significant advantages are realized by practice of the present invention. In a preferred embodiment, the method of the present invention comprises:
a) a compact vest that can be folded and placed under the airline or marine seat;
b) the vest having an opening to slip the head through and a waist belt restraining feature securing the vest around the chest of a passenger;
c) the vest having integrally attached two or more pressurized air or oxygen cylindrical cartridges;
d) said chest portion of the vest having air chamber cells fillable with air from said cartridges;
e) activation means for rupturing the closure of the cylindrical cartridges to discharge pressurized air or oxygen into air chamber cells surrounding the chest of the passenger wearing said vest;
f) a breathing tube attached at the proximal end to said air chamber cells, a closure valve provided midway in the breather tube and terminating in a mouthpiece at the distal end;
g) the passenger in a smoke filled environment wearing the vest, inflating said air chamber cells by actuation means, placing said mouthpiece within the mouth and opening the breathing tube closure valve to draw a fresh supply of air or oxygen from air chamber cells, preventing smoke induced affixation;
h) the inflated air cells with the closed breathing tube valve providing buoyancy support when the passenger falls into water in a water accident, saving the passenger from drowning;
   whereby the vest provides breathable air or oxygen in a smoke filled environment and provides buoyancy support in a water drowning event.

### BRIEF DESCRIPTION OF THE DRAWING

The invention will be more fully understood and further advantages will become apparent when reference is had to the following detailed description of the preferred embodiments of the invention and the accompanying drawing, in which:

FIG. 1 illustrates at 10 the key features of the Safety Vest Floatation System With Oxygen Supply;

FIG. 2 illustrates at 20 a user breathing air or oxygen from the inflated air chamber cells.

### DETAILED DESCRIPTION OF THE INVENTION

This invention relates to an under seat vest that can be worn by an airline or water ferry passenger. The vest has integrally attached two or more cartridges of air and the air contained therein is released to one or two vest cells present adjacent to the chest of the user by activating a pull lever or a pull belt. The air cell has an attached breathing tube with a closure valve present midway and terminates in a mouthpiece similar to an under water snorkel. In the event of smoke in the airline cabin, the user may activate the filling of the air cells by pulling the pull lever or pull belt provided to thereby release the content of the air cartridge into the vest air chamber cells. Next the valve on the breathing tube is opened and the mouthpiece is placed within the mouth of the user to receive breathable air. While the invention, as detailed above, uses a mouthpiece, the mouthpiece may be optionally a part of a close fitting hood that is not pressurized and has a transparent opening covering the eyes that protect the eyes from smoke while providing good visibility. If the passenger is immersed in water due to a water-landing event, the passenger dons the vest and activates the filling of the vest air chamber cells with the breathing tube valve closed. The filled air chamber cells provide buoyancy, thereby preventing drowning of the passenger. The breathing tube mouthpiece may be used to increase buoyancy of the vest by blowing additional, previously inhaled air into the air chamber cells when the breathing tube valve is momentarily opened.

The air or oxygen cylinders are available in the form of cartridges and the top portion can be readily punctured using a pin. The cartridges are typically pressurized to 3000 psi or 20680 kilopascals and have a pressurized volume of 20 to 30 cc, while larger cartridges may also be selected. The ambient pressure is 15 psi or 103 kilopascals and expansion of the pressurized air or oxygen results in an expansion of 200 times the ratio of 3000 divided by 15 and results in a cell volume of 4000 to 6000 cc for each cell which is adequate for breathing for several minutes, depending on the exertion level of the passenger. The air volume per breath is typically 400 to 500 cc and 6 breaths per minute is common. With oxygen, the amount needed is smaller.

FIG. 1 illustrates at 10 the key features of the safety vest floatation system with oxygen supply. The vest has a base frame 12 and an opening for the insertion of the head of the user at 14. The safety vest floatation system with oxygen supply 10 further includes a belt or harness 16 disposed and structured to fit generally about the waist of an individual. The harness 16 has its free ends detachably connected to one another by a buckle assembly 18. Further, each of the flotation vest with oxygen supply includes a buoyancy assembly 40 and 40′ cells which, when activated by lever 30, serves to provide the individual wearing the vest 10 with breathable air or oxygen as well as supporting the passenger in an appropriate orientation on or within a body of water. As indicated in the drawing, the buoyancy assembly of the flotation assembly 10 includes the base 12 having a buoyancy assembly defined by two inflatable air chamber cells 40 and 40′ each including a separate compressed air or oxygen canister 24 having an activating pull cord/handle 26, 28 associated therewith. As such, the interior of the air chamber cells 40 and 40′ may be independently but simultaneously inflated by activating the pull handle 28 to facilitate the supply of breathable air or oxygen into the cells 40 and 40′. The cells 40 and 40′ are connected to a breathing tube 25 one for each of the air chamber cells, as shown. The breathing tube 25 is provided with closure means 27 and terminates in a mouthpiece 21. The mouthpiece may be used for breathing in smoky situations or used to increase the buoyancy of the air chamber during a water accident by blowing through the mouthpiece 21. This inflation of air chamber cells 40 and 40′ also supports an individual in an intended orientation on or within a body of water. Additional structural and operative features associated with the flotation assembly 10 include at least a first signaling device generally indicated as 32 in the form of a signal light 34 powered by a battery assembly 36 attached to the flotation assembly in any convenient location.

FIG. 2 illustrates at 20 a user having mouthpiece placed within the mouth and breathing from inflated air chamber cells 40. The air from the air chamber cells 40 exits port 30 through tube 25 and enters the mouthpiece 21.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1) A safety vest floatation system comprising:
a) a foldable compact vest that can be placed under a seat of an airline or marine craft;
b) said vest having an opening to slip the head of a passenger through, and a waist belt restraining feature securing the vest around the chest of a passenger;
c) said vest having integrally attached pressurized air or oxygen cylindrical cartridges;
d) said chest portion of the vest having air chamber cells fillable with air from said cartridges;
e) activation means for rupturing the closure of said cylindrical cartridges to discharge pressurized air or oxygen into air chamber cells surrounding the chest of the passenger wearing said vest;
f) a breathing tube attached at the proximal end to said air chamber cells, a closure valve provided midway in the breather tube and terminating in a mouthpiece at the distal end;
g) the passenger in a smoke filled environment wearing the vest, inflating said air chamber cells using said actuation means, placing said mouthpiece within the mouth and opening the breathing tube closure valve to receive a fresh supply of air or oxygen, preventing smoke induced affixation; and
h) the inflated air chamber cells with the breathing tube valve closed proving buoyancy support when the passenger falls into water in a water accident, saving the passenger from drowning;
whereby said safety vest floatation system provides breathable air or oxygen in a smoke filled environment and provides buoyancy support in a water accident event.

2) The safety vest floatation system as recited by claim 1, wherein the mouthpiece is used to manually blow previously inhaled air into air chamber cells with said breathing tube valve open to increase the buoyancy of said vest during a water accident.

3) The safety vest floatation system as recited by claim 1, wherein said vest has two or more cylindrical cartridges.

4) The safety vest floatation system as recited by claim 1, wherein said cylindrical cartridges are pressurized to 20680 kilopascals (3000 psi).

5) The safety vest floatation system as recited by claim 1, wherein said cylindrical cartridges have a pressurized volume of 20 cc.

6) The safety vest floatation system as recited by claim 1, wherein said cylindrical cartridges have a pressurized volume of 30 cc.

7) The safety vest floatation system as recited by claim 1, wherein said activation means is triggered by pulling a lever.

8) The safety vest floatation system as recited by claim 1, wherein said activation means is triggered by pulling a belt handle.

9) The safety vest floatation system as recited by claim 1, wherein said cylinder has pure oxygen supply.

10) The safety vest floatation system as recited by claim 1, wherein said cylinder has enriched oxygen air supply.

11) The safety vest floatation system as recited by claim 1, wherein said mouthpiece is present in an unpressurized hood with transparent protection for eyes to prevent irritation to the eyes due to smoke.
